(19) United States
(12) Patent Application Publication
(10) Pub. No.: US 2026/0127427 A1
(43) Pub. Date: May 7, 2026

(54) RETRAINING A CLASSIFIER MACHINE LEARNING MODEL TO IMPROVE ACCURACY OF DETECTION

(71) Applicant: INTERNATIONAL BUSINESS MACHINES CORPORATION, ARMONK, NY (US)

(72) Inventors: Roman Alexander Pletka, Uster (CH); Dionysios Diamantopoulos, Zurich (CH); Charalampos Pozidis, Thalwil (CH); Yves Alexandre Beraldo dos Santos, Marana, AZ (US); Andrew D. Walls, SAN JOSE, CA (US)

(21) Appl. No.: 18/936,370

(22) Filed: Nov. 4, 2024

(51) Int. Cl. G06N 3/08

(52) U.S. Cl. CPC G06N 3/08

(57) ABSTRACT

Provided are a computer implemented method, system, and computer program product for retraining a classifier machine learning model to improve accuracy of detection. A feature vector is received that is classified by the classifier as having a first classification result. A determination is made of a second classification result for the received feature vector based on labeled feature vectors having labeled classification results. The classifier is retrained to output the second classification result from input comprising the received feature vector in response to determining that the first classification result is different from the second classification result.

### BACKGROUND OF THE INVENTION

### 1. Field of the Invention

The present invention relates to a computer implemented method, system, and computer program product for retraining a classifier machine learning model to improve accuracy of detection.

### 2. Description of the Related Art

Ransomware is a type of malware that is deployed to infiltrate a computer system and encrypts user data. The malevolent actor will then demand payment of money or a ransom to have the data unencrypted. A network intrusion detection system scans traffic on a network to detect malicious traffic containing ransomware. Machine learning based ransomware detection may use low-level memory access patterns at storage devices in a storage controller to detect presence of ransomware accessing the storage devices.

### SUMMARY

Provided are a computer implemented method, system, and computer program product for retraining a classifier machine learning model to improve accuracy of detection. A feature vector is received that is classified by the classifier as having a first classification result. A determination is made of a second classification result for the received feature vector based on labeled feature vectors having labeled classification results. The classifier is retrained to output the second classification result from input comprising the received feature vector in response to determining that the first classification result is different from the second classification result.

### BRIEF DESCRIPTION OF THE DRAWINGS

FIG. 1 illustrates an embodiment of a computing environment to retrain a classifier machine learning model to improve accuracy of classification.

FIG. 2 illustrates an embodiment of a feature vector of I/O operation information gathered at storage devices.

FIGS. 3, 4, and 5 illustrate embodiments of a similarity analyzer to retrain a classifier machine learning model.

FIGS. 6, 7, 8, 9, and 10 illustrate embodiments of operations performed by a similarity analyzer to determine whether a feature vector is similar to a labeled feature vector.

FIG. 11 illustrates a computing environment in which the components of FIGS. 1, 3, 4, and 5 may be implemented.

### DETAILED DESCRIPTION

Classifier machine learning models may be used to classify an occurrence of a harmful event, e.g., presence of ransomware, from input comprising features of system operations. However, the classifier may produce false positives indicating a harmful event when no such event happened or false negatives not indicating a harmful event when such an event did happen. In response to regular false positives, administrators may ignore classifications of harmful events after unnecessarily expend time and resources responding to a series of misclassified harmful events. Described embodiments provide improvements to computer technology to retrain a classifier to reduce the incidence of incorrect classifications, such as false positives or false negatives.

Feature vectors of attributes of system operations that are inputted to deployed classifiers may be gathered from systems implementing the classifier. For feature vectors that resulted in a classification of a harmful event, such as the presence of ransomware, a determination is made of a labeled feature vector that is most similar to the feature vector that resulted in the harmful classification. The labeled feature vector is labeled with a ground truth value indicating whether the labeled feature vector is associated with the harmful event or not. If the most similar labeled feature vector has a label indicating an absence of the harmful event, then the classifier wrongly classified the harmful event from the feature vector. The misclassified feature vector may be added to a training set to use to retrain the classifier to output indication of no harmful event or to output a classification different from the misclassification. This retraining reduces the likelihood that the retrained classifier will output in the future a false positive of indication of a harmful event from similar feature vector input. In this way, described embodiments improve the classifier classifications by reducing the incidence of false classifications and making the classifier more reliable and accurate.

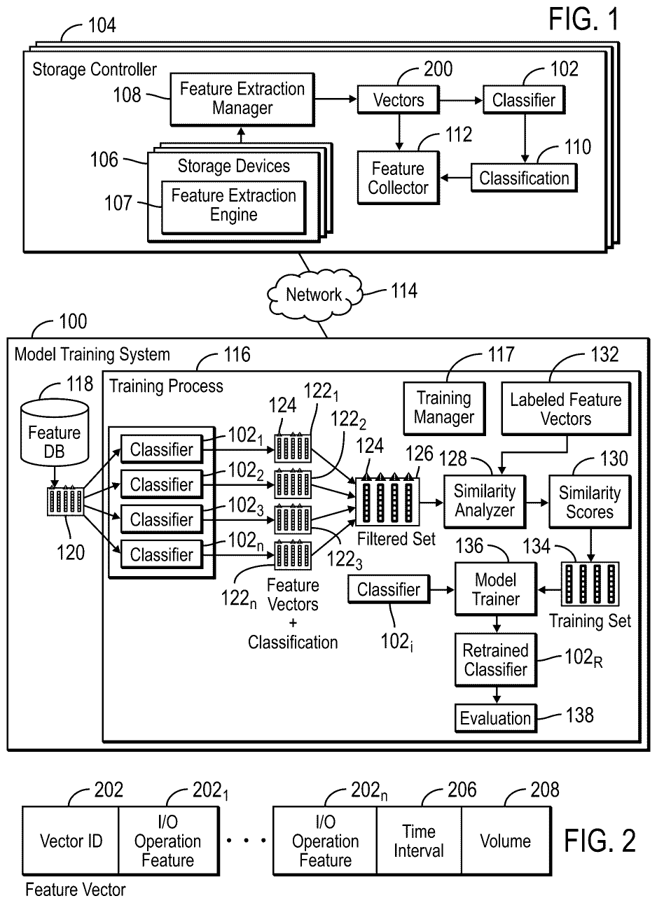

FIG. 1 illustrates an embodiment of a model training system 100 to train a classifier 102 machine learning model for deployment to storage controllers 104 providing access to a plurality of storage devices 106. Each of the storage devices 106 include a feature extraction engine 107 that gathers features of Input/Output (I/O) operation measurements or performance data at the storage device 106. The feature extraction engine 107 transmits the collected information to a feature extraction manager 108 in the storage controller 104. The feature extraction manger 108 aggregates the extracted features from the storage devices into vectors 200 that are provided to the classifier 102, e.g., inference engine. The classifier 102 outputs a classification 110 indicating, based on the extracted features in the vectors 200, whether the storage devices 106 are affected by malware or ransomware. The I/O operation features extracted from the storage devices 106 may comprise features related to read and write requests gathered and stored at the storage devices 106 including, but not limited to: entropy of data in a storage device 106, i.e., randomness of data; a compression ratio of the data in the storage device; logical block addresses (LBAs) to which I/O operations are directed; an I/O type; I/O size; I/O request rate; number of rewrites; read and write heat of regions of the storage devices indicating frequency of read and write access to a region of the storage, etc.

Extracted features may not be related to I/O operations, such as file system type, vendor, model, etc. Feature extraction may concern gathering statistics on all I/O operation features (unsampled) or sampled I/O operation features, such as a mean and variance of the data of the measurements. The I/O operation feature of LBAs may comprise a variance of access locations of LBAs, which may indicate an extent to which I/O access is sequential versus random. Additional features may be added by the feature extraction manager 108 that are computed from I/O operation features collected by the storage devices 106 or non-IO operation related features determined and maintained by the storage controller 104 such as the filesystem type, storage device model, storage device lifespan, etc. All these features may be highly predictive of whether the data in a storage device includes ransomware or malware.

The feature extraction manager 108 may further pass the aggregated I/O operation features to a feature collector 112. The feature collector 112 provides, over a network 114, the gathered vectors 200 to the model training system 100. The model training system 100 may exist in a cloud computing environment. The model training system 100 may retrain the classifier 102 machine learning model to improve the detection accuracy.

The training system 100 implements a training process 116 that is managed by a training manager 117. The gathered vectors 200 from the storage controllers 104 may be stored in a feature database 118. The training manager 117 may form segments 120 of vectors 200 from the database 118 of consecutive time series of vectors 200. A formed segment 120 is inputted to each of a plurality of classifiers 102₁, 102₂, 102₃ . . . 102ₙ, including previous version classifiers 102₁, 102₂ . . . 102ₙ₋₁ and a current version classifier 102ₙ. The classifiers 102ᵢ output the classifications, represented by icon 124, for the segments 122₁, 122₂, 122₃ . . . 122ₙ of vectors, which are the same as the input vectors 120. The reference “i” when used to designate an instance of an element, e.g., 102ᵢ and segments 122ᵢ, may refer to one or more of the instances of that element. The set of classifiers 102ᵢ may consist of currently deployed classifiers in production, new candidate models for the next model update under evaluation, or different workload-specific classifiers. The most current classifier 102ₙ may be used for determining the filtered data set 126. Alternatively, one or more other classifiers may be selected. In particular, one or more classifiers can be selected for forming a set of selected classifiers with the intent to improve the performance of the selected one or more classifiers in one or more new models to be trained. For example, the training manager 117 may filter the vectors 122ᵢ to form a filtered set 126 of vectors comprising the vectors 122ᵢ classified by any one or more of the classifiers 102₁, 102₂ . . . 102ₙ as having a first classification result 124, such as indicating ransomware. Thus, the filtered set 126 has those vectors 120, resulting from the one or more selected classifiers 122ᵢ, having the first classification result 124. Similarly, in another embodiment, the filtered data set 126 can be formed from a set of selected classifiers outputting other classifications.

In the embodiment of FIG. 1, the filtered set 126 of vectors 200 may be inputted to a similarity analyzer 128 to determine similarity scores 130 between the vectors in the filtered set 126 and labeled feature vectors 132 most similar to a vector in the filtered set 126. The labeled feature vectors 132 comprise feature vectors 200 labeled with a ground truth value, e.g., ransomware or not ransomware. The similarity analyzer 128 uses the similarity score to determine a labeled feature vector closet or most related to a feature vector in the filtered set. Cosine similarity may be used to determine the geographically closest labeled feature vector in a vector space. In one embodiment, the similarity analyzer 128 may subject the labeled feature vectors 132 to clustering with unsupervised learning to determine the predominant labeled feature vector or centroid of the labeled feature vectors that are labeled as indicating the same classification result, e.g., ransomware or not ransomware. The similarity analyzer may then use a cosine distance between the feature vector in the filtered set and the centroid or dominant labeled feature vector to determine whether they are sufficiently close in the vector space. If the classification result of the sufficiently close labeled feature vector differs from the classification result of the feature vector produced by the classifier, then the classification result from the classifier is considered wrong. A wrongly classified feature vector is added to the training set 134. Alternatively, the comparison of the feature vector from the filtered set can also be compared with a sufficiently close feature vector from the set of labeled feature vectors 132 by using a dedicated ML model that had been trained using the labeled feature vectors 132 to determine the probability whether two feature vectors given as input are considered to have the same label or not which is used as the similarity score 130.

The clustering determines a representative labeled feature vector of a set of labeled feature vectors, such as a centroid or dominant labeled feature vector. The similarity analyzer 128 may use unsupervised machine learning techniques, such as k-means and Principal Component Analysis (PCA), etc., to perform the clustering. To determine the similarity between a featured vector from the filtered set and a labeled centroid feature vector resulting from clustering, the similarity analyzer 128 may determine the spatial measurement in the multi-dimensional vector space using one of a cosine similarity, dot product measurement, a Manhattan distance measurement, and a Euclidean distance measurement.

A model trainer 136 may input the training set 134 of feature vectors into the current version of classifier 102ₙ to perform backpropagation to modify the weights and biases of the classifier 102ₙ machine learning model to output the label of the clustered labeled vectors, resulting in a retrained classifier 102_{R}. The retrained classifier 102_{R} may be subject to evaluation 138. The positively evaluated retrained classifier 102_{R} may be deployed to the storage controllers 104 and replace the current version of the classifier 102ₙ in the model training system 100.

In described embodiments, the client systems to which the classifier 102 is deployed comprise storage controllers 104. In alternative embodiments, for different types of classifiers for different computing environments, the client systems to which the classifier 102 is deployed may comprise other type of computing devices, such as hosts, servers, smartphones, personal computers, wearable computers, automobiles, etc.

FIG. 2 illustrates an embodiment of a vector 200ᵢ, formed by the feature extraction manager 108 from information collected in the storage devices 106, including a vector ID 202ᵢ the aggregate information for all the n I/O operation features 204₁ . . . 204ₙ; a time interval 206 during which the feature information was gathered, which may be used to determine a segment of vectors in a time series to impot to the classifier 102ᵢ; and a volume 208 for which the I/O operation features 204₁ . . . 204ₙ are generated. In certain embodiments, additional non-I/O related features may be added to the vector 200ᵢ by the feature extraction manager 108 as mentioned above.

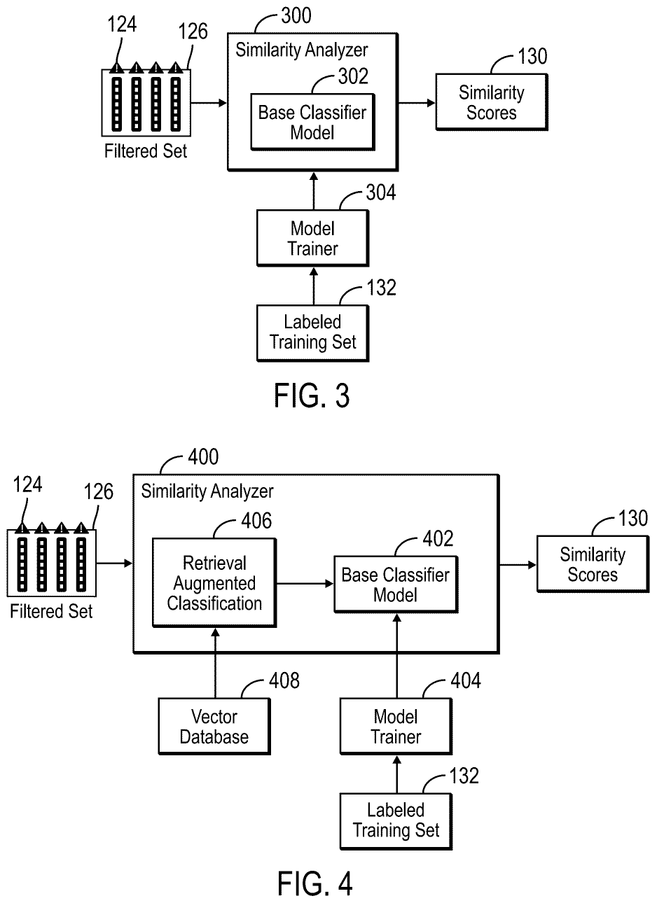

FIG. 1 uses the labeled feature vectors to determine classification results for the feature vectors through clustering of the labeled feature vectors. FIGS. 3-5 provide alternative embodiments for using the labeled feature vectors to determine a second classification result for a feature vector to compare with the first classification result from the classifier.

FIG. 3 illustrates an alternative embodiment of the similarity analyzer 128 in FIG. 1 as similarity analyzer 300 in FIG. 3. The similarity analyzer 300 includes a base classifier model 302, such as a machine learning model, that is trained on labeled feature vectors to form a stronger model than the classifiers 102ᵢ. The base classifier model 302 may require more computational resources and memory to run, such as a more extensive and complex neural network with more layers of nodes than the classifier 102ᵢ deployed in the storage controller 104. The base classifier model 302 may be deployed in the cloud to train the deployed local classifiers 102ᵢ that are less intensive neural networks. A model trainer 304 trains the base classifier model 302 with the labeled feature vectors 132 to output a classification result corresponding to the label for the labeled feature vector.

FIG. 4 illustrates an alternative embodiment of the similarity analyzer 128 in FIG. 1 as similarity analyzer 400. Similarity analyzer 400 includes the base classifier 402 and model trainer 404 described with respect to base classifier model 302 and model trainer 304 in FIG. 3. The base classifier 402 may comprise a more extensive neural network that is more computationally expensive and requires more memory than the classifier 102ᵢ. Similarity analyzer 400 further includes a retrieval augmented classification 406 to augment the feature vectors with labeled feature vectors from a vector database 408 of feature vectors from a high confident labeled training set. Clustering may be used to augment the input feature vectors from the filtered set with a closest labeled feature vector from the vector database 408. The feature vector from the filtered set that is augmented and one or more closest labeled feature vectors are inputted to the base classifier 302 to determine a classification result. The feature vectors from the filtered set and/or the set of n-closest labeled feature vectors retrieved from the vector database 408 may comprise a time series of vectors to classify.

In certain embodiments, the base classifier model 402 may comprise a large language model trained to classify time series of feature vectors from the filtered set. The time series of feature vectors may be compared to the labeled feature vectors to determine most similar labeled feature vectors to include in the time series to augment the input feature vectors inputted to the base classifier model 402.

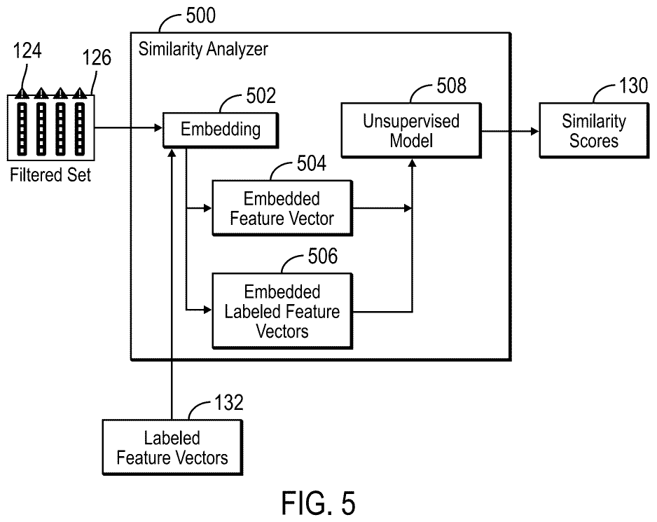

FIG. 5 illustrates an alternative embodiment of the similarity analyzer 128 in FIG. 1 as similarity analyzer 500. Similarity analyzer 500 includes an embedding 502 to receive as input a feature vector from the filtered set and labeled feature vectors to embed the feature vectors in a vector space. The embedding 502 may produce an embedded feature vector 504 from an inputted feature vector from the filtered set and produce embedded labeled feature vectors 506 from labeled feature vectors 132.

In certain embodiments, instead of inputting the entire feature vector/labeled feature vector to the embedding 502, only a subset of the most relevant elements in the feature vector may be inputted to the embedding 502 to map to the embedding space. The embedding 502 may be trained to embed the feature vectors 200 and labeled feature vectors to the embedded feature vectors 504, 506 providing numerical representations of the features in the domain. The domain may comprise I/O features related to storage devices that are relevant to predicting whether ransomware is writing to the storage devices. In other embodiments, the embedding model 132 may be trained for other types of domains and classifications. In certain embodiments, the feature vectors from the filtered set and the labeled feature vectors may be normalized before being processed by the embedding 502.

The embedded feature vector 504 and embedded labeled feature vectors 506 may be inputted to an unsupervised machine learning model 508 to perform clustering to find an embedded labeled feature vector closest to the input embedded feature vector 506. If the closest clustered embedded labeled feature vector, which may comprise a centroid, is within a threshold distance of the embedded feature vector 504, then the similarity module 510 may determine a similarity measurement between the feature vector from the filtered set and the closest labeled feature vector, such as a measurement determined by cosine similarity between the vectors.

The arrows shown in FIGS. 1 and 3-5 between the components and objects in the storage controller 104 and model training system 100 represent a data flow between the components.

Generally, program modules, such as the program components 102, 102₁ . . . 102ₙ, 102ᵢ, 102_{R}, 107, 108, 112, 116, 117, 128, 136, 300, 302, 304, 400, 402, 404, 406, 500, 502, 508, among others, may comprise routines, programs, objects, components, logic, data structures, and so on that perform particular tasks or implement particular abstract data types. The program components and hardware devices of the systems 100, 104 may be implemented in one or more storage systems or computer systems, where if they are implemented in multiple storage systems or computer systems, then the storage systems or computer systems may communicate over a network or a bus.

The program components 102, 102₁ . . . 102ₙ, 102ᵢ, 102_{R}, 107, 108, 112, 116, 117, 128, 136, 300, 302, 304, 400, 402, 404, 406, 500, 502, 508, among others, may be accessed by a processor from memory to execute. Alternatively, some or all of the program components 102, 102₁ . . . 102ₙ, 102ᵢ, 102_{R}, 107, 108, 112, 116, 117, 128, 136, 300, 302, 304, 400, 402, 404, 406, 500, 502, 508, among others, may be implemented in separate hardware devices, such as Application Specific Integrated Circuit (ASIC) hardware devices or a Field Programmable Gate Array (FPGA).

Program components implementing machine learning models, such as program components 102, 102₁ . . . 102ₙ, 102ᵢ, 102_{R}, 107, 108, 112, 128, 136, 300, 302, 304, 400, 402, 404, 406, 500, 502, 508, among others, may be implemented in an Artificial Intelligence (AI) hardware accelerator, such as an FPGA or a graphics processing unit (GPU).

In certain embodiments, program components 102, 102₁ . . . 102ₙ, 102ᵢ, 102_{R}, 107, 108, 112, 128, 136, 300, 302, 304, 400, 402, 404, 406, 500, 502, 508, among others, may use machine learning and deep learning algorithms, such as decision tree learning, XGBoost, Random Forest, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used by the model trainer 136 to train a neural network machine learning module, such as the classifier 102ᵢ, biases at nodes in the hidden layer are adjusted accordingly to produce the output, such as classification of a vector indicating presence of malware and ransomware, with specified confidence levels based on the input parameters. The program components 102, 102₁ . . . 102ₙ, 102ᵢ, 102_{R}, 107, 108, 112, 128, 136, 300, 302, 304, 400, 402, 404, 406, 500, 502, 508, among others, may be trained to produce their output from feedback and their output based on the input. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In backward propagation performed by the model trainer 136, used to train a neural network machine learning module, such as the program components 102, 102₁ . . . 102ₙ, 102ᵢ, 102_{R}, 107, 108, 112, 128, 136, 300, 302, 304, 400, 402, 404, 406, 500, 502, 508, margins of error are determined based on a difference of the calculated predictions and user rankings of the output. Biases (parameters) at nodes in the hidden layer are adjusted accordingly to minimize the margin of error of the error function.

In an alternative embodiment, the components 102, 102₁ . . . 102ₙ, 102ᵢ, 102_{R}, 107, 108, 112, 128, 136, 300, 302, 304, 400, 402, 404, 406, 500, 502, 508, may be implemented not as a machine learning module, but implemented using a rules based system to determine the outputs from the inputs, or be, implemented in methods other than neural networks, such as multivariable linear regression models. The component 128 may be implemented using an unsupervised machine learning module.

The functions described as performed by the program components 102, 102₁ . . . 102ₙ, 102ᵢ, 102_{R}, 107, 108, 112, 116, 117, 128, 136, 300, 302, 304, 400, 402, 404, 406, 500, 502, 508, among others, may be implemented as program code in fewer program modules than shown or implemented as program code throughout a greater number of program modules than shown.

The model training system 100 may comprise a server. The storage controller 104 may comprise a storage server, enterprise storage server, etc.

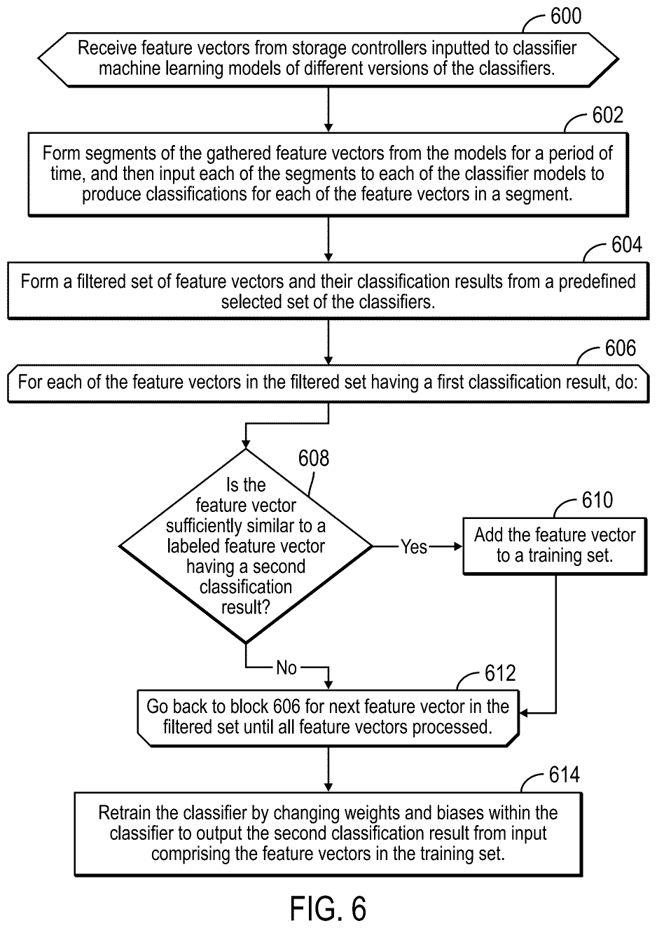

FIG. 6 illustrates an embodiment of operations performed by the training manager 117 and other components of FIG. 1, to retrain the classifier 102ₙ. The training system 100 receives (at block 600) feature vectors 200 from storage controllers 104 and classification results of inputting the feature vectors 200 to a set of classifiers 102₁ . . . 102ₙ for different versions, new candidate models, classifiers in production, different workload-specific classifiers, etc. The training manager 117 forms (at block 602) segments 122ᵢ of the gathered feature vectors 200 from the models 102ᵢ for a period of time, i.e., time series, and then inputs each of the segments 122ᵢ to each of the classifiers 102ᵢ to produce classification results 124 for each of the feature vectors 200 in a segment 122ᵢ. The segments 122ᵢ may be formed from, but not limited to, single feature vectors 200, non-overlapping consecutive feature vectors 200 as time series, or overlapping consecutive feature vectors 200 in a sliding window manner. The training manager 117 forms (at block 604) a filtered set of feature vectors and their classification results from a predefined selected set of one or more of the classifiers 102₁ . . . 102ₙ.

The training manager 117 performs a loop of operations at blocks 606 through 612 for each of the feature vectors in the filtered set 126 to determine feature vectors having the first classification result that is a false positive. If (at block 608) the feature vector 200, having a first classification result, e.g., indicating ransomware, is sufficiently similar to one of the labeled feature vectors 132, having a different second classification result, then the feature vector is added to the training set 134. A feature vector that is similar to a labeled feature vector having a different classification result indicates that the classifier 102ᵢ produced the wrong classification result for the feature vector because the labeled feature vector provides a ground truth classification result. For this reason, this feature vector for which the classifier 102ᵢ produced the wrong classification result is added to the training set 134 to use for retraining the classifier 102ᵢ. From block 610 or if (from the NO branch of block 608) the feature vector is not sufficiently similar to one of the labeled feature vectors 132, then control proceeds to block 612 to consider all feature vectors in the filtered set 126. The operations at block 606 may be performed for each feature vector in the filtered set 126 or processed in segments of feature vectors.

After assembling a training set 134 of feature vectors wrongly classified, such as false positives or false negatives, control proceeds to block 614 where the model trainer 136 retrains the classifier 102ᵢ by changing weights and biases within the classifier 102ᵢ to output the second classification result from input comprising the feature vectors in the training set 134.

This retraining results in the retrained classifier 102_{R}. The model trainer 136 may indicate a current classifier 102ₙ as a previous version classifier 102ₙ₋₁ and saves the retrained classifier 102_{R} as the current version classifier 102ₙ in the training system 100. The retrained classifier 102_{R} may be subject to evaluation 138. The training system 100 may then deploy the retrained classifier 102_{R} to the storage controllers 104 to use. Alternatively, if the storage controllers 104 invoke an inference engine in the cloud to perform classifications, then the inference engine may be updated with the retrained classifier 102_{R} for the storage controllers 104 to invoke.

With the embodiment of FIG. 6, feature vectors collected at different client devices or storage controllers 104 are provided to the training system 100. The feature vectors are processed by the classifiers 102ᵢ at the training system 100 to produce classifications. To reduce the likelihood of false positive or other false classifications, such as a false classification of ransomware, a determination is made of a labeled feature vector having a ground truth classification that is most similar, or closest in an embedded vector space, to a feature vector classified as a first value or harmful event. The classification of the closest ground truth labeled feature vector may be used to confirm whether the classification of the feature vector is correct. If the classification by the classifier 102ᵢ is not correct according to the most similar ground truth labeled feature vector, then the classifier 102n is retrained to produce the second classification result, e.g., no ransomware, from the considered feature vector. In this way, the classifier is retrained to reduce the likelihood of continued false positive classifications.

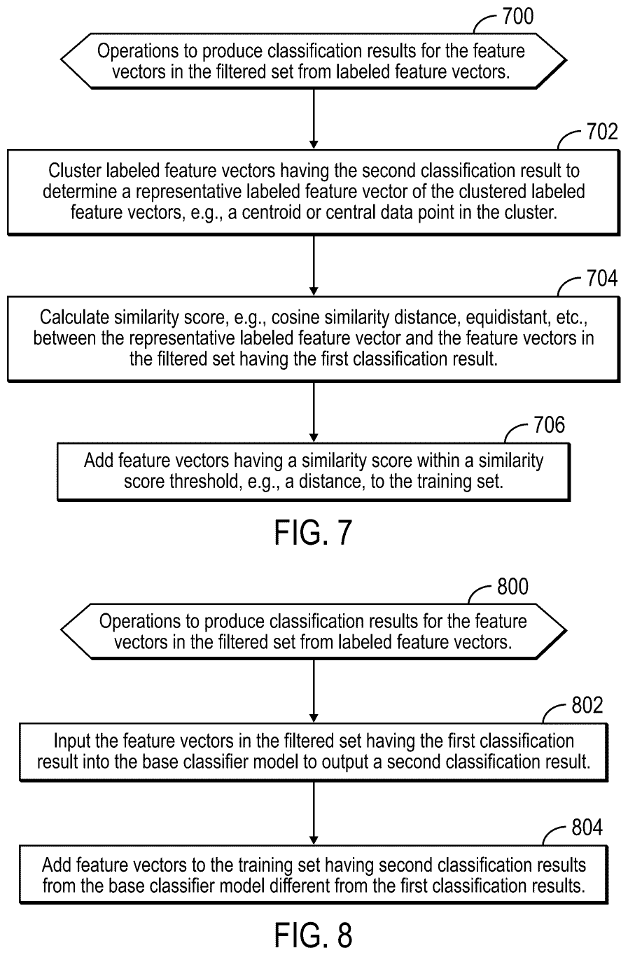

FIG. 6 provides one embodiment for using the labeled feature vectors to determine a second classification result for a feature vector. FIGS. 7-10 provide alternative embodiments of operations performed by the different embodiments of the similarity analyzer 300, 400, and 500 in FIGS. 3-5 to determine a second classification result for a feature vector based on the labeled feature vectors.

FIG. 7 illustrates an embodiment of operations performed by the similarity analyzer 300 in FIG. 3 to use clustering to determine the second classification result based on the labeled feature vectors. Upon initiating (at block 700) the operations to determine a second classification result, the similarity analyzer 300 may input the labeled feature vectors into an unsupervised machine learning model to cluster labeled feature vectors having the second classification result to determine a representative labeled feature vector of the clustered labeled feature vectors, e.g., a centroid or central data point in the cluster. The similarity analyzer 300 may then calculate (at block 704) a similarity score, e.g., cosine similarity distance, equidistant, etc., between the representative labeled feature vector and the feature vectors in the filtered set having the first classification result. Those feature vectors having a similarity score within a similarity score threshold, e.g., sufficiently close distance in the vector space, are added (at block 706) to the training set.

With the embodiment of operations of FIG. 7 a labeled feature vector that is a sufficient close distance to the feature vector in a vector space is used to confirm whether the first classification result of the feature vector is a false positive or correct. If a false positive, then that feature vector is used to retrain the classifier to output the second classification result for the feature vector.

FIG. 8 illustrates an embodiment of operations performed by the similarity analyzer 300 in FIG. 3 to use a base classifier 302 trained on the labeled feature vectors to determine the second classification result. Upon initiating (at block 800) the operations to determine a second classification result, the feature vectors in the filtered set having the first classification result are inputted (at block 802) into the base classifier model 302 in FIG. 3 to output a second classification result. Feature vectors having a second classification result different from the first classification result outputted by the classifier 102ᵢ are added (at block 804) to the training set.

In this way, the base classifier model 302 may comprise a more extensive and computationally expensive neural network than the classifier 102ᵢ. The base classifier model 302 may be used to determine whether a first classification result from the classifier is a false positive upon detecting the base classifier model 302 outputs a different second classification result.

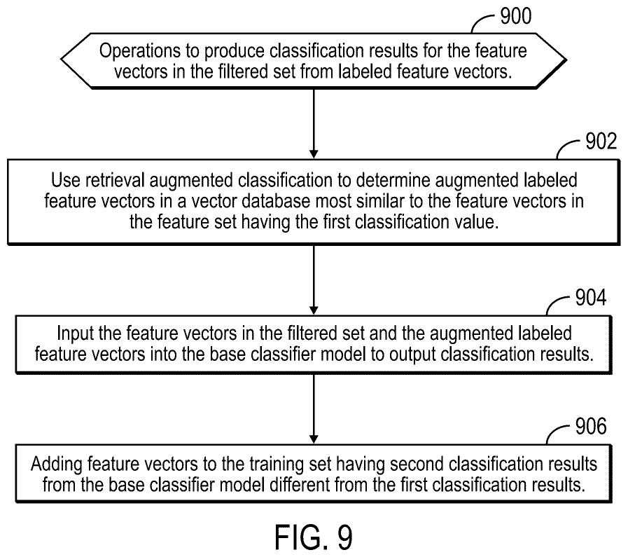

FIG. 9 illustrates an embodiment of operations performed by the similarity analyzer 400 in FIG. 4 to determine a second classification result for a feature vector. Upon initiating (at block 900) the operations to determine a second classification result, a retrieval augmented classification 406 determines (at block 902) augmented labeled feature vectors in a vector database 408 most similar to the feature vectors in the filtered set having the first classification value. The feature vectors in the filtered set and the determined augmented labeled feature vectors are inputted (at block 904) into the base classifier model 402 to output classification results. The feature vectors having a classification result from the base classification mode 402 different from the classification result produced by the classifier 102ᵢ are added (at block 906) to the training set.

In this way, the base classifier model 402 may comprise a more extensive and computationally expensive neural network than the classifier 102ᵢ. The base classifier model 402 may be used to determine whether a first classification result from the classifier is a false positive upon detecting the base classifier model 402 outputs a different second classification result. Alternatively, the base classifier model 402 may be trained with labeled feature vectors 132 to determine the probability whether two feature vectors given as input are considered to have the same label or not. The feature vectors received from the retrieval augmented classification 406 and the selected feature vectors can be used is input for such a model.

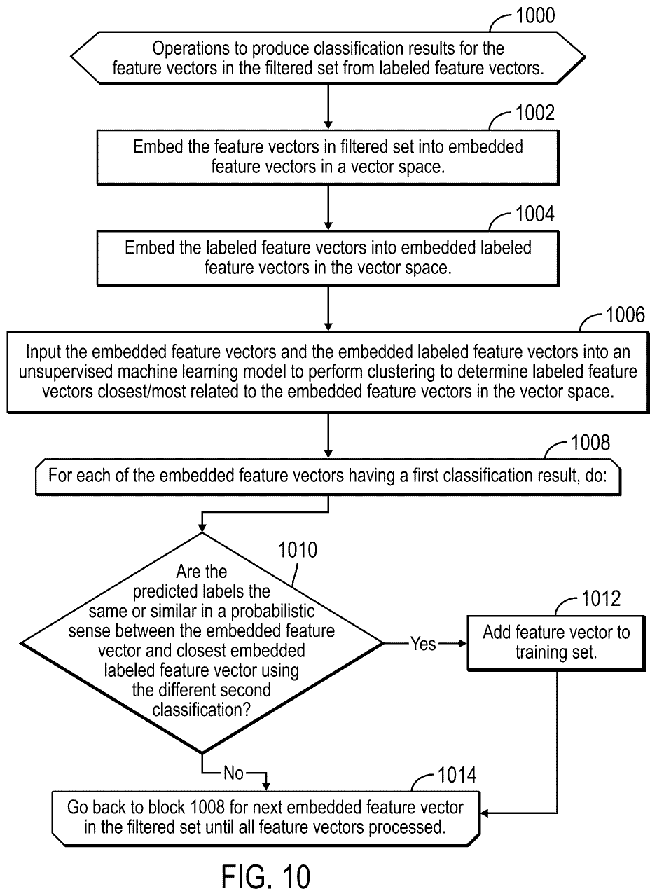

FIG. 10 illustrates an embodiment of operations performed by the similarity analyzer 500 in FIG. 5 to determine a second classification result based on the labeled feature vectors. Upon initiating (at block 1000) the operations to determine a labeled feature vector similar to a feature vector in the filtered set, the embedding 502 embeds (at block 1002) the feature vectors in the filtered set into embedded feature vectors 504 in a vector space. The embedding 502 embeds (at block 1004) the labeled feature vectors into embedded labeled feature vectors 506 in the vector space. The embeddings of the labeled feature vectors may be stored in a separate database from where they can be retrieved by the similarity analyzer. The embedded feature vectors 504 and the embedded labeled feature vectors 506 are inputted into an unsupervised machine learning model to perform clustering to determine labeled feature vectors closest/most related to the embedded feature vectors in the vector space.

A loop of operations is performed at blocks 1008 through 1014 for each of the embedded feature vectors having a first classification result. If (at block 1010) the predicted labels are the same or similar in a probabilistic sense between the embedded feature vector and closest embedded labeled feature vector using the different second classification result, then that feature vector is added (at block 1012) to the training set. From block 1012 or the NO branch of block 1010, control proceeds to block 1014 until all the embedded feature vectors having the first classification result are considered. The unsupervised model 508 may comprise the model being trained to output a label, the probability of labels, or whether two input feature vectors are likely to have the same label or not. Also, the distance between the embedded feature vectors from the filtered set and the closest embedded labeled feature vectors can be used to determine whether the embedded feature vectors are within a distance threshold for performing the comparison.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

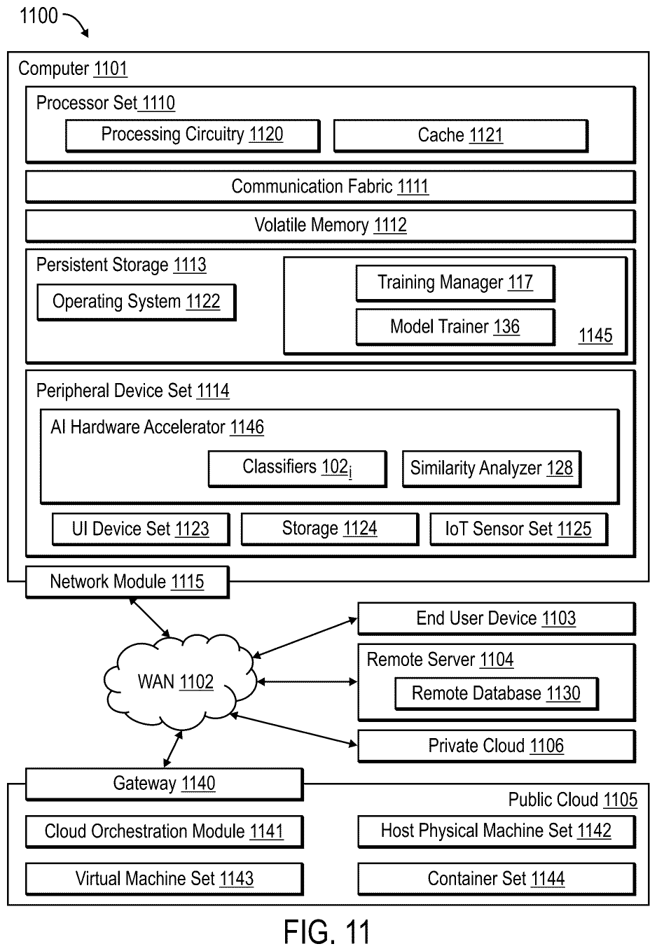

With respect to FIG. 11, computing environment 1100 contains an example of an environment for the execution of at least some of the computer code involved in performing the inventive methods, such as the components of the training process 116 described with respect to FIG. 11. Block 1145 may include a training manager 117 and model trainer 136 described with respect to FIG. 11. The peripheral device set 1114 may include an artificial intelligence (AI) hardware accelerator 1146 including the classifiers 102ᵢ and a similarity analyzer 128, 300, 400, 500 described above. In addition to blocks 1145 and 1146, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer-readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1145 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector. The AI hardware accelerator 1146 may include machine learning models 102₁, 128, 132, and 140 described with respect to FIG. 1.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer-readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on. The EUD 1103 may comprise the storage controllers 104 in FIG. 1 providing the feature vectors 200 gathered at the storage controllers 104.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

CLOUD COMPUTING SERVICES AND/OR MICROSERVICES (not separately shown in FIG. 11): private and public clouds 1106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for retraining a classifier comprising a machine learning model, comprising:
receiving a feature vector classified by the classifier having a first classification result;
determining a second classification result for the received feature vector based on labeled feature vectors having labeled classification results; and
retraining the classifier to output the second classification result from input comprising the received feature vector in response to determining that the first classification result is different from the second classification result.

2. The computer implemented method of claim 1, wherein the determining the second classification result based on the labeled feature vectors comprises:
clustering labeled feature vectors to determine a representative labeled feature vector of a cluster of the labeled feature vectors;
determining a similarity score between the representative labeled feature vector and the received feature vector; and
determining whether the similarity score exceeds a similarity threshold indicating a degree of similarity, wherein the second classification result comprises a label of the representative labeled feature vector.

3. The computer implemented method of claim 2, wherein the determining the similarity score comprises measuring a distance between the representative labeled feature vector and the received feature vector in a vector space.

4. The computer implemented method of claim 1, further comprising:
inputting the received feature vector through a plurality of classifiers to determine classification results;
selecting at least one of the classifiers;
forming a filtered set of feature vectors and classification results from the selected at least one classifier, wherein the second classification result is determined for the feature vectors in the filtered set; and
adding the feature vectors in the filtered set having the first classification result different from the second classification result to a training set, wherein the retraining the classifier to output the second classification result is performed for the feature vectors in the training set.

5. The computer implemented method of claim 1, wherein the determining the second classification result based on the labeled feature vectors comprises:
providing a base classifier model trained with a labeled training set to classify an input feature vector to a classification result, wherein the base classifier model comprises a more extensive neural network requiring greater memory and computational resources than the classifier, wherein the second classification result is outputted by the base classifier model.

6. The computer implemented method of claim 1, wherein the determining the second classification result based on the labeled feature vectors comprises:
using retrieval augmented classification to determine an augmented labeled feature vector in a vector database most similar to the received feature vector; and
providing a base classifier model trained with a labeled training set to classify an input feature vector and the augmented labeled feature vector as a classification result, wherein the second classification result is outputted by the base classifier model.

7. The computer implemented method of claim 1, wherein the determining the second classification result based on the labeled feature vectors comprises:
embedding the received feature vector into an embedded feature vector in a vector space;
embedding the labeled feature vectors into embedded labeled feature vectors;
inputting the embedded feature vector and the labeled feature vectors into an unsupervised machine learning model to perform clustering to determine an embedded labeled feature vector closest to the embedded feature vector; and
determining whether a distance between the embedded feature vector and the closest embedded labeled feature vector is within a distance threshold, wherein the second classification result comprises a label of the closest embedded labeled feature vector.

8. A system for retraining a classifier comprising a machine learning model, comprising:
a processor; and
a computer readable storage medium including program instructions that when executed by the processor causes operations, the operations comprising:
receiving a feature vector classified by the classifier having a first classification result;
determining a second classification result for the received feature vector based on labeled feature vectors having labeled classification results; and
retraining the classifier to output the second classification result from input comprising the received feature vector in response to determining that the first classification result is different from the second classification result.

9. The system of claim 8, wherein the determining the second classification result based on the labeled feature vectors comprises:
clustering labeled feature vectors to determine a representative labeled feature vector of a cluster of the labeled feature vectors;
determining a similarity score between the representative labeled feature vector and the received feature vector; and
determining whether the similarity score exceeds a similarity threshold indicating a degree of similarity, wherein the second classification result comprises a label of the representative labeled feature vector.

10. The system of claim 9, wherein the determining the similarity score comprises measuring a distance between the representative labeled feature vector and the received feature vector in a vector space.

11. The system of claim 8, further comprising:
inputting the received feature vector through a plurality of classifiers to determine classification results;
selecting at least one of the classifiers;
forming a filtered set of feature vectors and classification results from the selected at least one classifier, wherein the second classification result is determined for the feature vectors in the filtered set; and
adding the feature vectors in the filtered set having the first classification result different from the second classification result to a training set, wherein the retraining the classifier to output the second classification result is performed for the feature vectors in the training set.

12. The system of claim 8, wherein the determining the second classification result based on the labeled feature vectors comprises:
providing a base classifier model trained with a labeled training set to classify an input feature vector to a classification result, wherein the base classifier model comprises a more extensive neural network requiring greater memory and computational resources than the classifier, wherein the second classification result is outputted by the base classifier model.

13. The system of claim 8, wherein the determining the second classification result based on the labeled feature vectors comprises:
using retrieval augmented classification to determine an augmented labeled feature vector in a vector database most similar to the received feature vector; and
providing a base classifier model trained with a labeled training set to classify an input feature vector and the augmented labeled feature vector as a classification result, wherein the second classification result is outputted by the base classifier model.

14. The system of claim 8, wherein the determining the second classification result based on the labeled feature vectors comprises:
embedding the received feature vector into an embedded feature vector in a vector space;
embedding the labeled feature vectors into embedded labeled feature vectors;
inputting the embedded feature vector and the labeled feature vectors into an unsupervised machine learning model to perform clustering to determine an embedded labeled feature vector closest to the embedded feature vector; and
determining whether a distance between the embedded feature vector and the closest embedded labeled feature vector is within a distance threshold, wherein the second classification result comprises a label of the closest embedded labeled feature vector.

15. A computer program product for retraining a classifier comprising a machine learning model, comprising a computer readable storage medium including program instructions that when executed by a processor perform operations, the operations comprising:
receiving a feature vector classified by the classifier having a first classification result;
determining a second classification result for the received feature vector based on labeled feature vectors having labeled classification results; and
retraining the classifier to output the second classification result from input comprising the received feature vector in response to determining that the first classification result is different from the second classification result.

16. The computer program product of claim 15, wherein the determining the second classification result based on the labeled feature vectors comprises:
clustering labeled feature vectors to determine a representative labeled feature vector of a cluster of the labeled feature vectors;
determining a similarity score between the representative labeled feature vector and the received feature vector; and
determining whether the similarity score exceeds a similarity threshold indicating a degree of similarity, wherein the second classification result comprises a label of the representative labeled feature vector.

17. The computer program product of claim 15, wherein the operations further comprise:
inputting the received feature vector through a plurality of classifiers to determine classification results;
selecting at least one of the classifiers;
forming a filtered set of feature vectors and classification results from the selected at least one classifier, wherein the second classification result is determined for the feature vectors in the filtered set; and
adding the feature vectors in the filtered set having the first classification result different from the second classification result to a training set, wherein the retraining the classifier to output the second classification result is performed for the feature vectors in the training set.

18. The computer program product of claim 15, wherein the determining the second classification result based on the labeled feature vectors comprises:
providing a base classifier model trained with a labeled training set to classify an input feature vector to a classification result, wherein the base classifier model comprises a more extensive neural network requiring greater memory and computational resources than the classifier, wherein the second classification result is outputted by the base classifier model.

19. The computer program product of claim 15, wherein the determining the second classification result based on the labeled feature vectors comprises:
using retrieval augmented classification to determine an augmented labeled feature vector in a vector database most similar to the received feature vector; and
providing a base classifier model trained with a labeled training set to classify an input feature vector and the augmented labeled feature vector as a classification result, wherein the second classification result is outputted by the base classifier model.

20. The computer program product of claim 15, wherein the determining the second classification result based on the labeled feature vectors comprises:
embedding the received feature vector into an embedded feature vector in a vector space;
embedding the labeled feature vectors into embedded labeled feature vectors;
inputting the embedded feature vector and the labeled feature vectors into an unsupervised machine learning model to perform clustering to determine an embedded labeled feature vector closest to the embedded feature vector; and
determining whether a distance between the embedded feature vector and the closest embedded labeled feature vector is within a distance threshold, wherein the second classification result comprises a label of the closest embedded labeled feature vector.
